SEQUENCE LISTING (6 sequences)

SEQ ID NO: 1 - DNA, 17 bp, Artificial Sequence
  Synthetic oligonucleotide
ggttcacttgcgtaact

SEQ ID NO: 2 - DNA, 16 bp, Artificial Sequence
  Synthetic oligonucleotide
ttctccaggctcgttg

SEQ ID NO: 3 - DNA, 15 bp, Artificial Sequence
  Synthetic oligonucleotide
tgcgtcccacacggc

SEQ ID NO: 4 - DNA, 15 bp, Artificial Sequence
  Synthetic oligonucleotide
ggctcaacaaacgcg

SEQ ID NO: 5 - DNA, 16 bp, Artificial Sequence
  Synthetic oligonucleotide
tttctgtcaccgtccg

SEQ ID NO: 6 - DNA, 85 bp, Artificial Sequence
  Synthetic oligonucleotide
nnnnnnnnagtctgtccannnnnnnnnnnccgagctacgtccaatnnnnnnnnnnnnnngtcctgcaannnnnnnnnnnnnnnnn

(19) United States
(12) Patent Application Publication
(10) Pub. No.: US 2017/0017820 A1
(43) Pub. Date: Jan. 19, 2017

(54) Automatic Processing Selection Based on Tagged Genomic Sequences

(71) Applicant: EXIQON A/S, Vedbaek (DK)

(72) Inventor: Lars Kongsbak, Vedbaek (DK)

(21) Appl. No.: 14/798,956

(22) Filed: Jul. 14, 2015

(51) Int. Cl. G06K 7/14; H04L 29/06

(52) U.S. Cl. CPC G06K 7/1413; H04L 63/10

(57) ABSTRACT

A computing system may receive an encoded representation of a biological sample. The encoded representation may contain an embedded barcode, and the computing system may include locked features. Possibly based on the embedded barcode, the computing system may automatically select a data processing pipeline for the encoded representation. Also possibly based on the embedded barcode, the computing system may unlock one or more of the locked features. The computing system may process the encoded representation in the selected data processing pipeline and according to the one or more unlocked features.

### BACKGROUND

Genetic sequencing and testing has recently evolved from a series of expensive procedures that took months or years to perform, to a relatively inexpensive and common procedure that can be rapidly accessed by the general public. By extracting information from a genome, scientists and researchers can obtain valuable insights regarding organisms' genealogies, evolution, and susceptibilities to various diseases.

While this sequencing and testing has become mainstream, it is still in an early stage with regard to usability and efficiency. In particular, since multiple nucleotide sequences from different sources may be processed in parallel, these sequences are given the same overall treatment. Doing so prevents sequencing systems from providing customized processing on a per-sequence basis.

### SUMMARY

In an example embodiment, a computing system may receive an encoded representation of a biological sample. The encoded representation may contain an embedded barcode, and the computing system may include locked features. Possibly based on the embedded barcode, the computing system may automatically select a data processing pipeline for the encoded representation. Also possibly based on the embedded barcode, the computing system may unlock one or more of the locked features. The computing system may process the encoded representation in the selected data processing pipeline and according to the one or more unlocked features.

In a second example embodiment, an article of manufacture may include a non-transitory computer-readable medium, having stored thereon program instructions that, upon execution by a computing system, cause the computing system to perform operations in accordance with the first example embodiment.

In a third example embodiment, a computing system may include at least one processor, as well as data storage and program instructions. The program instructions may be stored in the data storage, and upon execution by the at least one processor may cause the computing system to perform operations in accordance with the first example embodiment.

In a fourth example embodiment, a system may include various means for carrying out each of the operations of the first example embodiment.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a high-level depiction of a client-server computing system, according to an example embodiment.

FIG. 2 illustrates a schematic drawing of a computing device, according to an example embodiment.

FIG. 3 illustrates a schematic drawing of a networked server cluster, according to an example embodiment.

FIG. 4 depicts a sequencing pipeline, according to an example embodiment.

FIG. 5A depicts an embedded barcode, according to an example embodiment.

FIG. 5B depicts two ways of embedding barcodes, according to example embodiments.

FIG. 6 is a flow chart, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### 1. Overview

For purposes of the disclosure herein, a “biological sample” may be any sample that contains deoxyribonucleic acid (DNA) or ribonucleic acid (RNA), or both, such as an organ, tissue, cell, or cell extract isolated from a subject. A biological sample may also be a cell or cell line created under experimental conditions, and might not be directly isolated from a subject. A biological sample can also be cell-free, artificially derived, or synthesized. For instance, the embodiments described herein may be used for the analysis of free-floating DNA and RNA from bio-fluids such as blood, saliva, urine, spinal cord fluid, etc., the analysis of fossils (see, e.g., Willerslev et al. Science (2003) 300, 791-5), or environmental surveillance (see, e.g., Ficetola et al. Biol. Lett. (2008) 4, 423-425; Thomsen et al. PLoS One. (2012) 7(8):e41732). Moreover, the biological sample may contain information other than the sequence of the DNA or RNA, such as epigenetic information or protein sequence information.

Genetic sequencing may involve determining the order of nucleotides in a biological sample, such as a fragment of DNA or RNA. Each nucleotide contains one base structure (or nucleobase) which may be adenine (A), guanine (G), cytosine (C), or thiamine (T) for DNA. In RNA, thiamine bases are replaced by uracil (U) bases. RNA can be divided into multiple categories, two of which are messenger RNA (mRNA) and micro RNA (miRNA). Messenger RNA includes RNA molecules that are transcribed from a DNA template and that convey genetic information from DNA to a ribosome, where they specify amino acid sequences. Micro RNA includes non-coding RNA molecules (usually containing about 17-25 nucleotides) and can regulate gene expression.

A strand of DNA or RNA may include tens, hundreds, thousands, millions, or billions of nucleotides in a particular ordering. Complete DNA sequences, or genomes, of various organisms have been discovered via a group of techniques generically referred to as “sequencing.” Doing so has led to medical research advances in areas such as diagnosis, forensics, and bioinformatics.

Rather than attempting to sequence an entire genome in a monolithic operation, relatively short fragments of DNA or RNA (e.g., a few hundred or a few thousand nucleotides) may be sequenced individually. Various techniques may be used to fit these fragments together to reliably determine much longer sequences of genetic material. For example, a genome could be broken into various overlapping fragments, and each fragment may be individually sequenced. The genome can be recreated by ordering the sequenced fragments according to their overlapping regions. The sequencing of the individual fragments may involve steps of amplification and electrophoresis.

In order to sequence RNA, complementary DNA (cDNA) for single-strand RNA may be made, and the steps below may take place on the resultant DNA. However, other RNA sequencing techniques are possible, and the embodiments herein do not require the example sequencing technique below to be used.

Amplification refers to the copying of a fragment of DNA. Various amplification techniques may be used to make multiple copies of such a fragment from a small initial sample. For instance, polymerase chain reaction (PCR) is an amplification technique that can rapidly produce thousands of copies of a fragment.

Using PCR, the fragment containing the DNA sequencing target, primers (short single-stranded DNA fragments containing subsequences are that are complimentary to the sequencing target), free nucleotides, and a polymerase are placed in a thermal cycler. Therein, the sequencing target undergoes one or more cycles of denaturation, annealing, and extension.

In the denaturation phase, the thermal cycler is set to a high temperature, which breaks the hydrogen bonds between bases of the sequencing target. The results are two complementary single-stranded DNA molecules. In the annealing phase, the thermal cycler is set to a lower temperature, which allows bonding of the primers to the single-stranded molecules. Once the primers are bonded to the appropriate locations of the single-stranded molecules, the extension phase begins. The thermal cycler is set to an intermediate temperature (e.g., a temperature between those used in the denaturation and annealing phases), and the polymerase binds complementary free nucleotides along the single-stranded molecules, effectively creating a copy of the original two-stranded DNA sequencing target.

These three phases repeat any number of times, creating an exponentially-growing number of copies of the original sequencing target. For example, in only a few hours, one million or more copies of the original sequencing target may be produced.

An initially popular method of DNA sequence was the Sanger sequencing method. In order to facilitate sequencing the original sequencing target by this method, dideoxynucleotides (ddNTPs) are added to the free nucleotides. A ddNTP has the same chemical structure as the free nucleotides, but is missing a hydroxyl group at the 3′ position (e.g., at the end of the molecule to which DNA polymerase incorporates the subsequent nucleotide). Consequently, if a ddNTP is incorporated into a growing complementary strand during the extension phase, it may act as a polymerase inhibitor because the missing hydroxyl group prevents the strand from being elongated. Because the incorporation of ddNTPs is random, when the polymerization process iterates, DNA strands identical to the original sequencing target, but of different lengths, may be produced. If enough polymerization iterations take place for an original sequencing target of n base pairs, new copies of lengths 1 through n may be produced, each terminating with a ddNTP.

The DNA strands can be observed by radiolabeling the probe and resolving each of various lengths using electrophoresis. Alternatively, the ddNTPs for each types of base (e.g., A, C, G, and T) may be fluorescently-labeled with different dyes (colors) that emit light at different wavelengths. Thus, the A ddNTPs may have one color, the C ddNTPs may have another color, and so on. This enables the use of capillary electrophoresis to separate and detect the DNA strands based on size.

In electrophoresis, the replicated sequencing targets are placed in a conductive gel (e.g., polyacrylamide). The gel is subject to an electric field. For instance, a negatively-charged anode may be placed on one side of the gel and a positively-charged cathode may be placed on the other. Since DNA is negatively charged, the sequencing targets (i.e., the elongated strands) can be introduced to the gel near the anode, and they will migrate toward the cathode. Particularly, the shorter the sequencing target, the faster and further it will migrate. After some period of time, the sequencing targets may be arranged in order of decreasing length, with longer sequencing targets near the anode and shorter sequencing targets near the cathode. Similarly, fluorescently-labeled DNA strands by resolved and detected using capillary electrophoresis.

For fluorescently-labeled DNA strands, since the terminating nucleotide of each fragment is a colored ddNTP, computer imaging can be used to determine the sequence of nucleotides by scanning the colored ddNTP in each sequencing targets from those near the cathode to those near the anode. Alternatively, the colored ddNTP incorporated into each fragment can be identified as each fragment migrates past as fixed detector based on its size. By reading the ordered fluorescent molecules, the computer can provide a sequence of nucleotides represented as strings of bases in letter form (e.g., ACATGCATA). With a sequencing target sequenced in this fashion, the next sequencing target of the genome can be sequenced, and so on. Then, these sequencing targets may be ordered, by the computer, to form a representation of the genome. This ordering may be based on a reference genome, or in a de novo fashion without a reference genome.

The techniques described herein, however, are not limited by the type of sequencing. To that point, advances in computer processing and storage technologies have led to so-called “next-generation sequencing” techniques. While next-generation sequencing may include various procedures, in general they involve use of massively parallel computing to speed the sequencing process. For example, rather than processing sequenced DNA fragments one at a time, millions of such sequencing targets may be processed in parallel. Various algorithms may be used to identify the ordering of these sequencing targets.

Additionally, the parallel aspect of next-generation sequencing provides flexibility in terms of the level of resolution used during sequencing. For example, a sequencing operation can be tailored to produce more data or less data, zoom in with high resolution on particular regions of the genome, and/or provide a global view with a lower resolution. To adjust the level of resolution, the average number of sequenced fragments that align to each base can be tuned. For example, a whole genome sequenced at 25 times coverage results in, on average, each base in the genome being covered by 25 sequenced fragments.

A high degree of coverage may be useful to detect rare DNA mutations. Using mixed-cell samples, the region of DNA harboring such a mutation might be sequenced at up to 1000 times or more, to detect the mutations within the cell population. Another application that may benefit from increased coverage is de novo sequencing, where fragments are assembled without aligning to part a reference genome. The coverage quality of a de novo sequencing data set depends upon the quality of the contiguous sequences generated by aligning overlapping fragments. The larger the size and continuity of the contiguous sequences, the fewer gaps are present in the sequenced genome. By increasing the coverage of fragments used for de novo sequencing, the extent of overlapped contiguous sequences is expected to grow.

Further, fragments from disparate biological samples can be processed in parallel in a method called multiplexing. To accomplish this, individual and unique tags, in the form of nucleic acid barcodes, may be added to each biological sample so that they can be differentiated from other samples during processing.

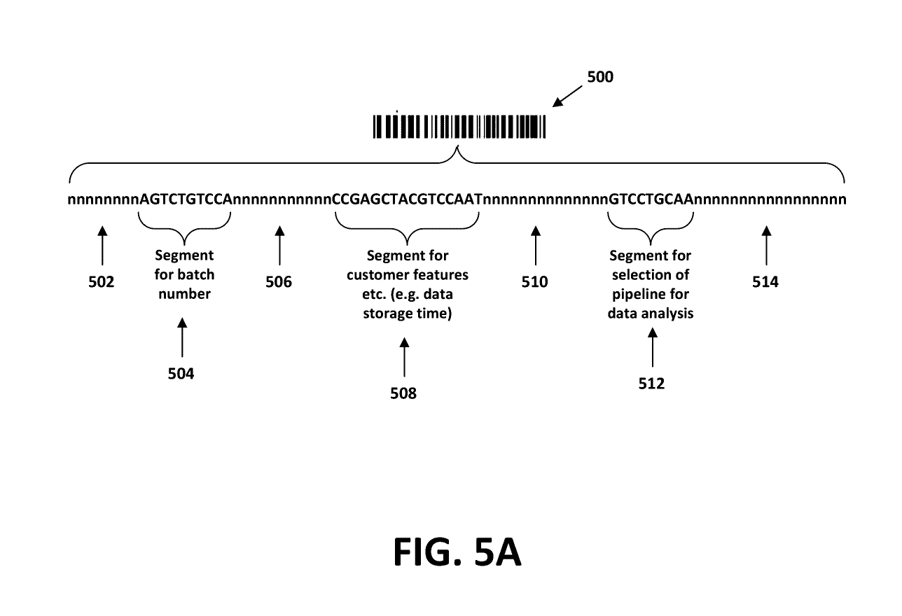

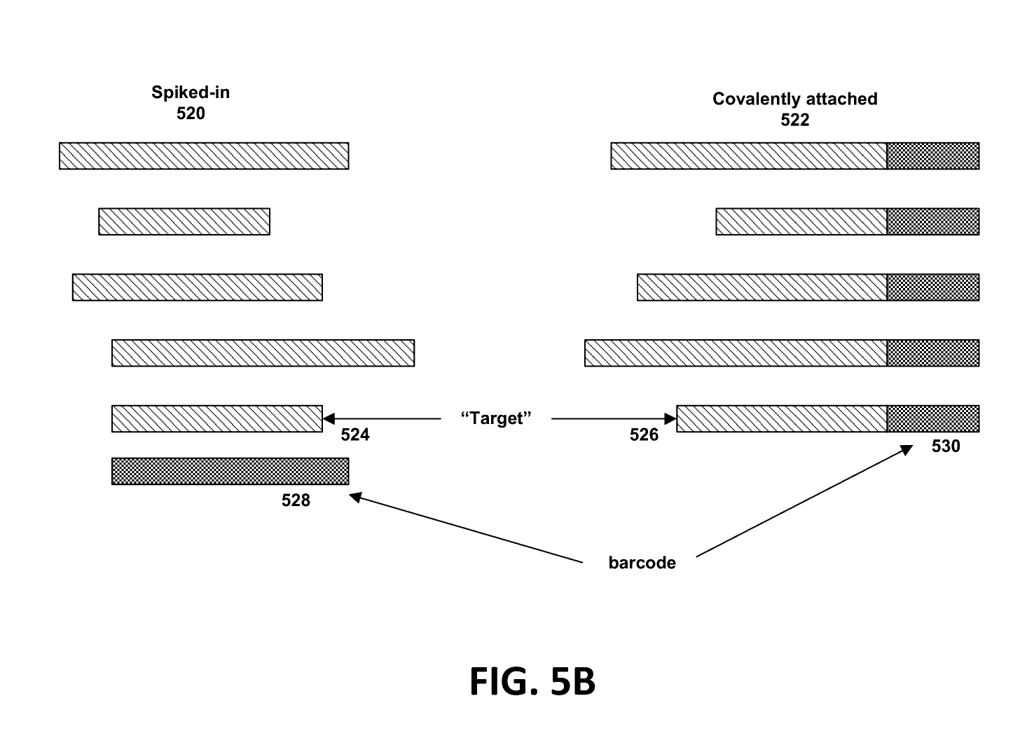

In one embodiment, the barcode is what may be referred to as a “spike-in control nucleic acid molecule,” “spike-in molecule” or just a “spike-in.” In another embodiment, the barcode is covalently attached to each target nucleotide sequence (see FIG. 5B for depictions of both). Regardless, the barcode may be a DNA or RNA molecule of about 15-30 nucleotides (e.g., if the target nucleic acid molecule is a micro RNA) or 175-275 nucleotides (e.g., for DNA or messenger RNA target molecules). Other numbers of nucleotides may be used. The barcode may consist of a nucleotide sequence that does not appear in any of the DNA fragments being processed. Barcodes can be made by generating sequences known not to be present in any naturally occurring nucleic acid or that encodes any naturally occurring protein. In some cases, random sub-sequences can be included in the barcode. As such, a barcode can be used to tag or identify each DNA fragment without being confused with any part of the fragment.

For instance, a unique barcode can be added directly to each biological sample at the time of collection or receipt of the sample, or at a later stage of processing. In some cases, a barcode molecule may be added to the substrate of a DNA or RNA testing kit, as one possible implementation. In this way, the biological sample or can be tracked through each stage of processing subsequent to the addition of the barcode. In some embodiments, the processing involves one or more transfers of the biological sample to different containers, or processing of a digital representation of the sequenced sample according to various rules. Further, an identity of the biological sample or containing the barcode can be verified at particular stages in processing.

Once combined, the biological samples and their associated barcodes may be subsequently inseparable. Thus, the barcoded DNA or RNA is processed along with the original DNA or RNA through one or more of sample preparation, sequencing, and analysis. For example, a barcode can be detected by PCR and/or sequencing.

To enable such detection, barcodes may be recorded in a computer database, and the database can be queried for a match between the determined sequence of a processed biological sample and an entry in the database. Such a match can be used to verify the identity of the biological sample. For example, one or more of the determined sequence(s) of a biological sample may be aligned with a first reference barcode from the database to determine the presence or absence of a match. In the presence of a match, the identity of the determined sequence(s) of the biological sample is verified. In the absence of a match, the determined sequence(s) of a biological sample may be re-aligned with a second or subsequent reference barcode from the database, until a match is found.

Once the barcode added to a particular sequenced DNA fragment is found, it may be removed from the fragment or otherwise ignored. In this way, the fragment can be processed as if the barcode did not exist.

The integrity of the sequencing data derived from a biological sample may be dependent on the ability of the data to unambiguously identify the biological sample. A risk of incorrectly associating sequencing results and input samples is incurred at each step of sequencing, from initial sample acquisition through nucleotide extraction, modification and amplification, to sequence data generation on a particular data processing platform. Any sequencing error, for example from cross-contamination between samples, likely renders any data derived from the sequencing of these samples to be useless. Therefore, use of such barcodes can improve the overall sequencing process.

A barcode may be used to identify a particular entity, such as an individual, group, customer, or business account. Further, a barcode may also be used to identify the type of computer processing (e.g., different processing for DNA, RNA, and micro RNA) that should be undertaken for one or more sequenced fragments. Alternatively or additionally, a barcode may indicate how long data representing one or more sequenced fragments should be stored (e.g., 1 month, 3 months, 6 months, etc.). In some cases, a barcode may be used to identify applications for the design of assays, or to identify the assays themselves. Moreover, a barcode may be used to provide various discounts to physical or online orders of such assays. In full generality, multiple barcodes may be used per biological sample, with each barcode potentially serving a different function. In some embodiments, a barcode can represent several subsets of nucleotide patterns, each potentially serving a different function.

Thus, the presence of barcode molecules can be used to unlock features of a computer—particular those of a computer processing pipeline. These features may result in a DNA or RNA sequence associated with the barcode being processed according to particular rules, functionality, or characteristics. Various types of computing systems and devices may be employed to carry out the operations described herein. Examples are provided in the following section.

### 2. Example Computing Systems, Devices, and Cloud-Based Computing Environments

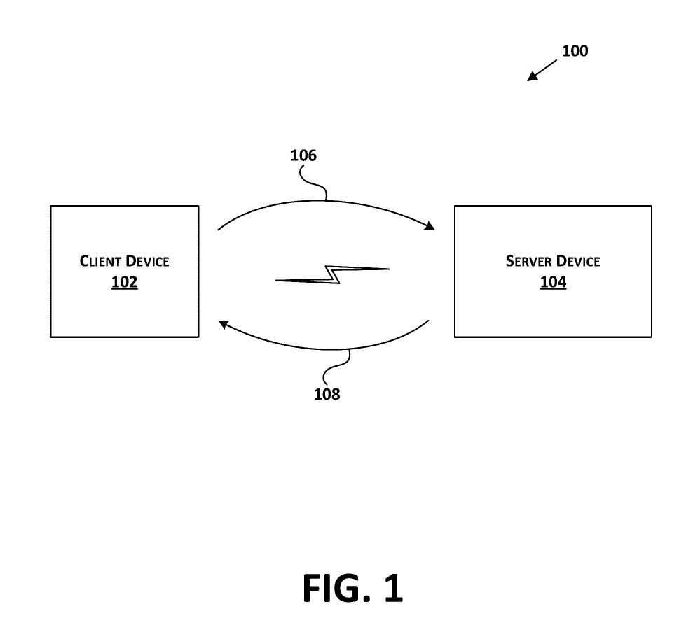

FIG. 1 illustrates an example communication system 100 for carrying out one or more of the embodiments described herein. Communication system 100 may include computing devices. Herein, a “computing device” may refer to either a client device, a server device (e.g., a stand-alone server computer or networked cluster of server equipment), or some other type of computational platform.

Client device 102 may be any type of device including a personal computer, laptop computer, a wearable computing device, a wireless computing device, a head-mountable computing device, a mobile telephone, or tablet computing device, etc., that is configured to transmit data 106 to and/or receive data 108 from a server device 104 in accordance with the embodiments described herein. For example, in FIG. 1, client device 102 may communicate with server device 104 via one or more wireline or wireless interfaces. In some cases, client device 102 and server device 104 may communicate with one another via a local-area network. Alternatively, client device 102 and server device 104 may each reside within a different network, and may communicate via a wide-area network, such as the Internet.

Client device 102 may include a user interface, a communication interface, a main processor, and data storage (e.g., memory). The data storage may contain instructions executable by the main processor for carrying out one or more operations relating to the data sent to, or received from, server device 104. The user interface of client device 102 may include buttons, a touchscreen, a microphone, and/or any other elements for receiving inputs, as well as a speaker, one or more displays, and/or any other elements for communicating outputs.

Server device 104 may be any entity or computing device arranged to carry out the server operations described herein. Further, server device 104 may be configured to send data 108 to and/or receive data 106 from the client device 102.

Data 106 and data 108 may take various forms. For example, data 106 and 108 may represent packets transmitted by client device 102 or server device 104, respectively, as part of one or more communication sessions. Such a communication session may include packets transmitted on a signaling plane (e.g., session setup, management, and teardown messages), and/or packets transmitted on a media plane (e.g., text, graphics, audio, and/or video data).

Regardless of the exact architecture, the operations of client device 102, server device 104, as well as any other operation associated with the architecture of FIG. 1, can be carried out by one or more computing devices. These computing devices may be organized in a standalone fashion, in cloud-based (networked) computing environments, or in other arrangements.

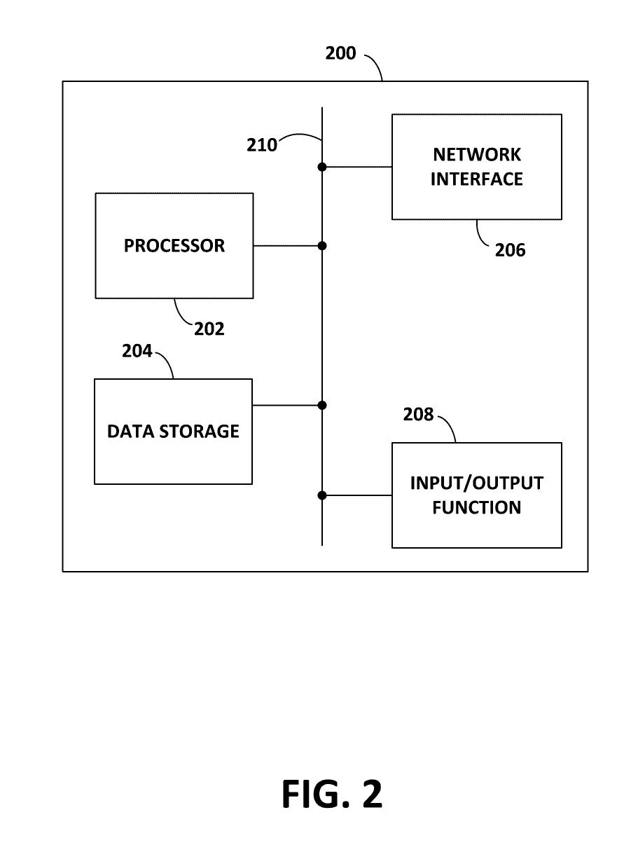

FIG. 2 is a simplified block diagram exemplifying a computing device 200, illustrating some of the functional components that could be included in a computing device arranged to operate in accordance with the embodiments herein. Example computing device 200 could be a client device, a server device, or some other type of computational platform. For purposes of simplicity, this specification may equate computing device 200 to a server from time to time. Nonetheless, the description of computing device 200 could apply to any component used for the purposes described herein.

In this example, computing device 200 includes a processor 202, a data storage 204, a network interface 206, and an input/output function 208, all of which may be coupled by a system bus 210 or a similar mechanism. Processor 202 can include one or more CPUs, such as one or more general purpose processors and/or one or more dedicated processors (e.g., application specific integrated circuits (ASICs), digital signal processors (DSPs), network processors, etc.).

Data storage 204, in turn, may comprise volatile and/or non-volatile data storage and can be integrated in whole or in part with processor 202. Data storage 204 can hold program instructions, executable by processor 202, and data that may be manipulated by these instructions to carry out the various methods, processes, or operations described herein. Alternatively, these methods, processes, or operations can be defined by hardware, firmware, and/or any combination of hardware, firmware and software. By way of example, the data in data storage 204 may contain program instructions, perhaps stored on a non-transitory, computer-readable medium, executable by processor 202 to carry out any of the methods, processes, or operations disclosed in this specification or the accompanying drawings.

Network interface 206 may take the form of a wireline connection, such as an Ethernet, Token Ring, or T-carrier connection. Network interface 206 may also take the form of a wireless connection, such as IEEE 802.11 (Wifi), BLUETOOTH®, or a wide-area wireless connection. However, other forms of physical layer connections and other types of standard or proprietary communication protocols may be used over network interface 206. Furthermore, network interface 206 may comprise multiple physical interfaces.

Input/output function 208 may facilitate user interaction with example computing device 200. Input/output function 208 may comprise multiple types of input devices, such as a keyboard, a mouse, a touch screen, and so on. Similarly, input/output function 208 may comprise multiple types of output devices, such as a screen, monitor, printer, or one or more light emitting diodes (LEDs). Additionally or alternatively, example computing device 200 may support remote access from another device, via network interface 206 or via another interface (not shown), such as a universal serial bus (USB) or high-definition multimedia interface (HDMI) port.

In some embodiments, one or more computing devices may be deployed in a networked architecture. The exact physical location, connectivity, and configuration of the computing devices may be unknown and/or unimportant to client devices. Accordingly, the computing devices may be referred to as “cloud-based” devices that may be housed at various remote locations.

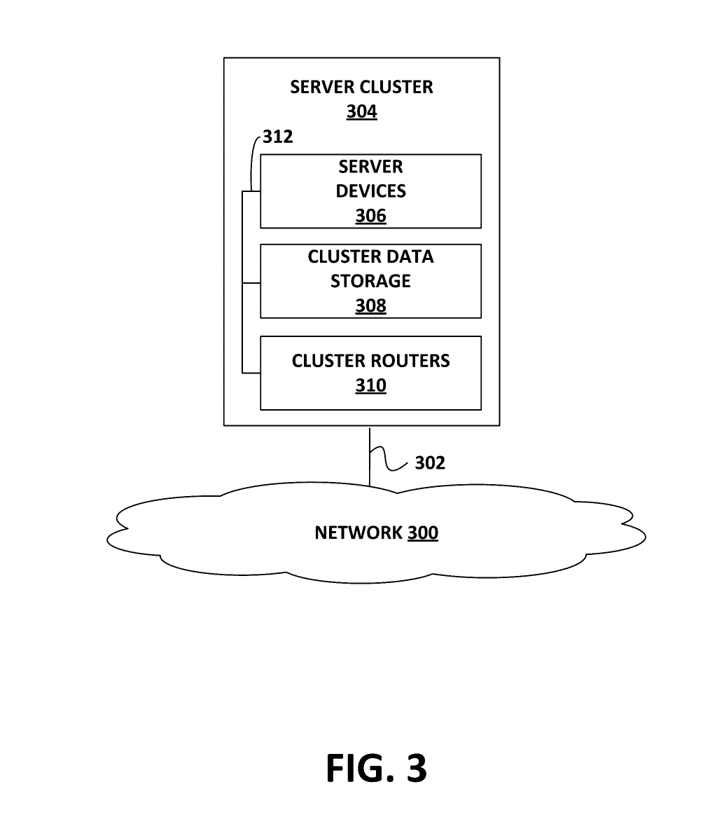

FIG. 3 depicts a cloud-based server cluster 304 in accordance with an example embodiment. In FIG. 3, functions of a server device, such as server device 104 (as exemplified by computing device 200) may be distributed between server devices 306, cluster data storage 308, and cluster routers 310, all of which may be connected by local cluster network 312. The number of server devices, cluster data storages, and cluster routers in server cluster 304 may depend on the computing task(s) and/or applications assigned to server cluster 304.

For example, server devices 306 can be configured to perform various computing tasks of computing device 200. Thus, computing tasks can be distributed among one or more of server devices 306. To the extent that these computing tasks can be performed in parallel, such a distribution of tasks may reduce the total time to complete these tasks and return a result. For purposes of simplicity, both server cluster 304 and individual server devices 306 may be referred to as “a server device.” This nomenclature should be understood to imply that one or more distinct server devices, data storage devices, and cluster routers may be involved in server device operations.

Cluster data storage 308 may be data storage arrays that include disk array controllers configured to manage read and write access to groups of hard disk drives. The disk array controllers, alone or in conjunction with server devices 306, may also be configured to manage backup or redundant copies of the data stored in cluster data storage 308 to protect against disk drive failures or other types of failures that prevent one or more of server devices 306 from accessing units of cluster data storage 308.

Cluster routers 310 may include networking equipment configured to provide internal and external communications for the server clusters. For example, cluster routers 310 may include one or more packet-switching and/or routing devices configured to provide (i) network communications between server devices 306 and cluster data storage 308 via cluster network 312, and/or (ii) network communications between the server cluster 304 and other devices via communication link 302 to network 300.

Additionally, the configuration of cluster routers 310 can be based at least in part on the data communication requirements of server devices 306 and cluster data storage 308, the latency and throughput of the local cluster networks 312, the latency, throughput, and cost of communication link 302, and/or other factors that may contribute to the cost, speed, fault-tolerance, resiliency, efficiency and/or other design goals of the system architecture.

As a possible example, cluster data storage 308 may include any form of database, such as a structured query language (SQL) database. Various types of data structures may store the information in such a database, including but not limited to tables, arrays, lists, trees, and tuples. Furthermore, any databases in cluster data storage 308 may be monolithic or distributed across multiple physical devices.

Server devices 306 may be configured to transmit data to and receive data from cluster data storage 308. This transmission and retrieval may take the form of SQL queries, and the output of such queries, respectively. Additional text, images, video, and/or audio may be included as well. Furthermore, server devices 306 may organize the received data into web page representations. Such a representation may take the form of a markup language, such as the hypertext markup language (HTML), the extensible markup language (XML), or some other standardized or proprietary format. Moreover, server devices 306 may have the capability of executing various types of computerized scripting languages, such as but not limited to Perl, Python, PHP Hypertext Preprocessor (PHP), Active Server Pages (ASP), Javascript, and so on. Computer program code written in these languages may facilitate the providing of web pages to client devices, as well as client device interaction with the web pages

### 3. Example Barcode Uses

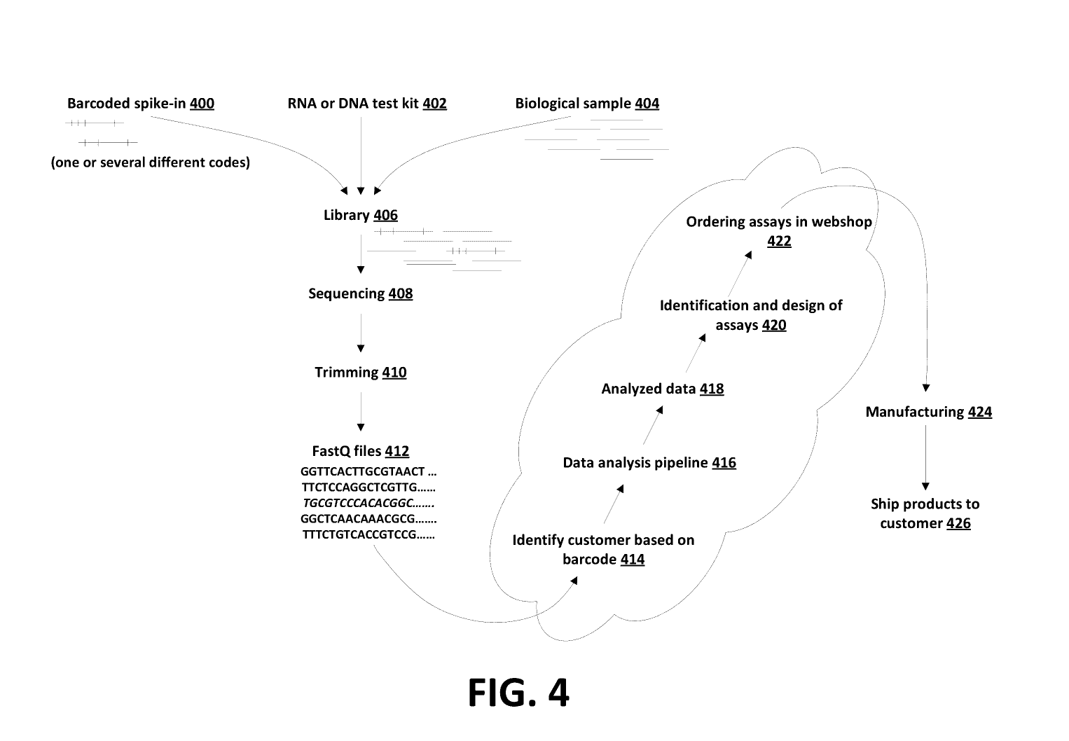

FIG. 4 depicts an example computerized DNA and/or RNA data analysis pipeline, along with other related steps. In FIG. 4, the pipeline steps 414, 416, 418, 420, and 422 are shown surrounded by a cloud to indicate that these steps may be performed by a cloud-based computing system, such as server cluster 304. Nonetheless, other steps in FIG. 4, such as steps 408, 410, and/or 412, may also be partially or wholly computerized.

As shown in steps 400, 402, 404, and 406, a barcoded spike-in containing one or more distinct barcodes may be combined with a DNA or RNA test kit. As noted above, the barcodes may be nucleotide sequences that are expected not to be found in a biological sample that is to be tested by the test kit. The test kit itself may include a solution in which to hold the biological sample, and perhaps a tool with which to obtain a biological sample.

For instance, biopsied tissue may be placed into the solution, sealed, and then sent to a lab for testing. Alternatively, a tool may be used to scrape the inside of a patient's mouth, or to collect a patient's blood or hair. Then the collected sample and/or the tool may be placed in the solution, sealed, and sent to the lab. In some cases, the barcoded nucleotide sequence may be integrated with the solution, and may be associated with a product identifier of the test kit, such as a serial number and/or lot number.

Regardless, the test kit, barcoded sequence, and the biological sample may be combined at step 406 into a library. As illustrated, the library contains DNA or RNA fragments from the sample that have been integrated with the barcoded sequence. For instance, some or all of these fragments may include the barcoded sequence.

At step 408, the fragments are sequenced. In some embodiments, the sequencing may take place according to the procedures described above, such as PCR and electrophoresis. However, other sequencing techniques may be used.

At step 410, the sequenced fragments are trimmed. Automated DNA sequencing occasionally produces poor quality sequences, particularly near the primer site, and toward the end of longer sequence runs. For instance, introns (nucleotide sequences that do not code for proteins) and primer sequences may flank the target fragment. Unless removed by trimming, either of these artifacts may distort downstream sequence analysis.

The result of this trimming is shown at step 412 in the form of example FastQ files. This computer file format encodes DNA or RNA sequences in using ASCII characters to represent the base of each nucleotide. Thus, each FastQ file may contain a digital representation of one or more sequenced fragments. Further, the one or more FastQ files may encode the barcodes. Although the FastQ file format can be used with the embodiments herein for digital representation of sequence data, there may be other formats that can be used as well. Thus, the FastQ file format is just one possible example of how the sequence data can be represented.

In particular, the barcodes may be combined with the DNA or RNA from the biological sample such that the sequencing and trimming steps take place without knowledge of which nucleotides are from the barcodes and which are from the biological sample. Thus, the FastQ files may contain the sequenced barcodes embedded with the sequenced DNA or RNA. While FIG. 4 shows the sequenced barcode in italic and the sequenced DNA or RNA in a non-italic font, this distinction is made for purposes of illustration. The actual FastQ files might not contain an indication of which nucleotides are associated with either the sequenced barcode or the sequenced DNA or RNA.

As noted previously, steps 414, 416, 418, 420, and 422 may be computer-implemented, such as on server cluster 304 or a standalone server device. In some cases, these steps may take place on cloud-based servers. Thus, the entity performing the sequencing and trimming may upload the resulting FastQ files to the cloud-based servers for processing. The entity that provided the biological sample (which, for sake of simplicity, will be referred to as the “customer”) may have an account on the cloud based servers so that this entity can view the results of the processing and analysis of the FastQ files. The customer may access the server-based account by way of a client device, such as client device 102.

At step 414, the customer may be identified by a barcode embedded in one or more of the FastQ files. As noted above, the customer may be an individual, group, business, or another type of entity. Based on the identified customer, a data analysis pipeline may be selected at step 416. For instance, the test kit may be purposed for one of DNA, RNA, or micro RNA testing. Thus, the barcode associated with the test kit may indicate that an appropriate data analysis pipeline (e.g., a DNA data analysis pipeline, RNA data analysis pipeline, or micro RNA data analysis pipeline) should be selected for processing the FastQ files. In this way, the customer does not have to instruct the cloud-based servers as to which pipeline to activate. Once the customer-identifying barcode is located and used, it may be masked from the FastQ files so that it is not revealed to customers.

Step 416 may involve any type of analysis of the FastQ files. For instance, an encoded DNA or RNA sequence may be subjected to any of a wide range of analytical methods to understand the features, function, structure, or evolution of the sequence. Example methodologies may include sequence alignment and searches against known sequences in biological databases.

After execution of the selected data analysis pipeline is completed, the analyzed data may be stored at step 418. This data may be stored in the cloud-based servers, or storage devices associated with the cloud-based servers. Particularly, a barcode (which may be the same as or different from the barcode used to identify the customer) may indicate how long the data is to be stored. As examples, the barcode may indicate that the data is to be stored for 30 days, 60 days, 180 days, etc. Further, the barcode may indicate whether the data is to be backed up and/or encrypted.

At step 420, based on the analyzed data, assays may be identified and/or designed. Each assay may be a specific type of test designed to provide further information to the customer. Example assays may include, but are not limited to, DNase footprinting, filter binding, gel shift, nuclear run-on, and/or ribosome profiling. Identification and purchase of these assays may be offered, by way of the cloud-based servers, to customers. For instance, the analyzed data may indicate that DNase footprinting may be an appropriate follow-on test for the biological sample; thus, the DNase footprinting assay may be offered for sale. Additionally, this offer may be provided at a discount to the customer. The discount may be an institutional discount or a personal discount, and may be based on the barcode that identified the customer.

Moreover, the embodiments described herein may have diagnostic uses. However, in such cases, there is a possibility that an individual may receive unwanted information from a genetic test. For example, a woman might undertake such a test because she is concerned about whether she carries genetic mutations predisposing her to breast cancer and/or giving birth prematurely. This woman might not want to receive the “complete” results of the test, which could allow her to see if she is predisposed to other maladies, e.g., Huntington's disease. The present embodiments can be specifically designed to the particularly needs of the individual costumer, and can be structured to ensure that such unwanted data is removed from any results reported to the customer or elsewhere.

At step 422, the customer may purchase and/or order one or more of the recommended assays in a web shop. The latter may be a web-based site that guides the customer through an e-commerce transaction in order to complete the purchase. For instance, the customer may be prompted to select a payment method, enter payment credentials, enter shipping information (e.g., the user's address), and so on. Alternatively, this payment and/or shipping information may be stored at the cloud-based servers and retrieved as needed. Once ordered, one or more assays may be manufactured at step 424, then shipped to the customer at step 426.

FIG. 5A depicts an example barcode 500. In FIG. 5A, this barcode includes four segments 502, 506, 510, and 514 representing random nucleotides, and three segments 504, 508, 512 representing nucleotides that may be used to control or unlock features of cloud-based servers. For instance, segment 504 identifies a batch number of the test kit, segment 508 identifies customer features (such as the amount of time the data is to be stored), and segment 512 identifies a data analysis pipeline to be selected. Thus, multiple functions are encoded in barcode 500. However, each of these functions could be encoded in a different barcode.

Segments 502, 506, 510, and 514 contain random nucleotides which may be ignored by the cloud-based servers. By including this randomness in the barcodes, barcodes are more difficult to guess, and less likely to collide with (be the same as) other barcodes. It should be understood that segments 504, 508, and 512 may also contain one or more randomly-chosen nucleotides, but these segments map to specific feature or functions to unlock in the cloud-based servers, whereas segments 502, 506, 510, and 514 might not.

In some embodiments, segments 504, 508, and 512 may be at fixed offsets from the beginning of the barcode. For instance, as shown in FIG. 5A, segment 504 may start at the 9^{th} nucleotide and continue through the 18^{th} nucleotide, whereas segment 506 may start at the 30^{th} nucleotide and continue through the 45^{th} nucleotide, and segment 508 may start at the 60^{th} nucleotide and continue through the 68^{th} nucleotide.

In other embodiments, the number of random nucleotides in segments 502, 506, 510, and 514 may vary. Thus, determining the beginning of segments 504, 506, and 508 may involve detecting a pattern that does not occur elsewhere in the fragment. As an example, segment 504 begins with the nucleotide sequence AGTC. The random nucleotides in segments 502, 506, 510, and 514 may be selected so that this pattern does not appear therein (arguably, these nucleotides would no longer be as random, but they would retain sufficient entropy for the purposes herein). Similarly, segments 508 and 512 may be selected to that this pattern does not appear therein.

Then, for instance, segment 504 may be identified by parsing through the fragment until the nucleotide sequence AGTC is found, and reading the 10 nucleotides starting therewith as the encoded batch number. Similar processing could be performed for segments 506 and 508. In this way, the number of random nucleotides before or after any of segments 504, 506, and 508 may encode further information. This further information could unlock additional features of the cloud-based servers. For instance, a sequence of 10 random nucleotides appearing between segments 504 and 506 may unlock one feature, whereas a sequence of 11 random nucleotides appearing between these segments may unlock a different feature.

FIG. 5A is an illustration of an example barcode. Barcodes with more or fewer segments (e.g., 1-10) that may be used to control or unlock features of server devices are possible.

FIG. 5B depicts two ways in which a barcode can be embedded with target nucleotides. Particularly, the barcode can be spiked-in with a mixture of target nucleotide sequences, covalently attached to each target nucleotide sequences, or both. In FIG. 5B, barcode 528 is spiked-in 520 with target nucleotide sequences 524, whereas barcode 530 is covalently attached 522 to each target nucleotide sequences 526.

Both the spiked-in and the covalently attached barcode variations have their advantages. The spiked-in variation is simple to apply and may be of a length comparable to that of the target nucleotide sequences. This technique may be used with next-generation sequencing to estimate expression values. On the other hand, the covalently attached variation allows parallel processing of unrelated samples (e.g. samples from different customers) in step 408 and at least some of the following steps. Thus, this procedure would allow pooling of different samples and imply a reduction of cost over the multiplexing technique described above. Further, the covalently attached variation may allow for quality control of the ligation process in step 406, as well as quality control of sequencing accuracy) for cross-contamination.

### 4. Example Operations

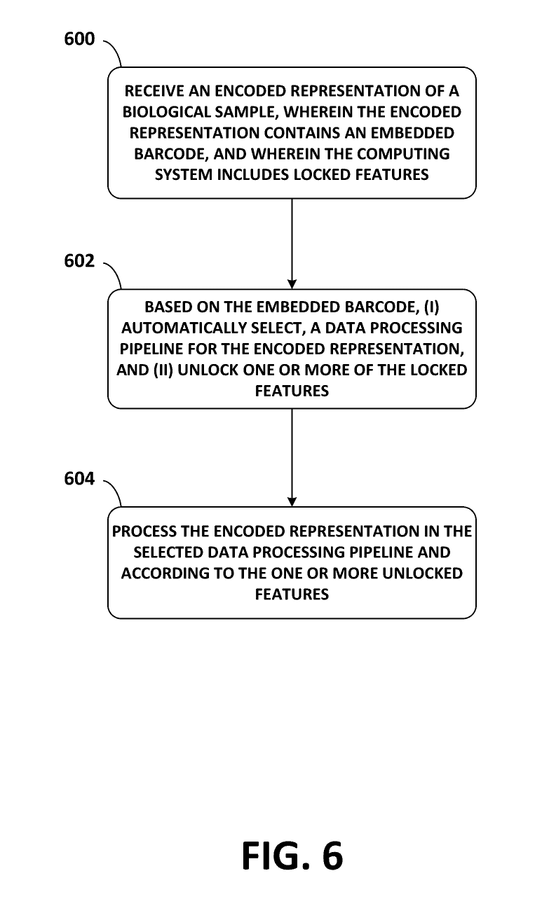

FIG. 6 is a flow chart illustrating a method according to an example embodiment. The process illustrated by FIG. 6 may be carried out by a computing device, such as computing device 200, and/or a cluster of computing devices, such as server cluster 304. However, the process can be carried out by other types of devices or device subsystems. For example, the process could be carried out by a portable computer, such as a laptop or a tablet device.

Block 600 may involve receiving an encoded representation of a biological sample. The encoded representation may contain an embedded barcode. The embedded barcode may identify a particular biological test kit. The encoded representation may be processed by a computing system that includes locked features.

Block 602 may involve, possibly based on the embedded barcode, (i) automatically selecting a data processing pipeline for the encoded representation, and (ii) unlocking one or more of the locked features of the computing system. The selected data processing pipeline may be one of a micro RNA pipeline, a long RNA pipeline, or a DNA pipeline. Other types of pipelines are possible.

Block 604 may involve processing the encoded representation in the selected data processing pipeline and according to the one or more unlocked features. As noted above, this processing may include determining longer sequences of genetic material from encoded fragments. Further, this processing may include determining, from one or more fragments, various types of assays to recommend.

In some embodiments, unlocking the one or more of the locked features may involve determining an entity type associated with the embedded barcode, and possibly based on the entity type, determining to unlock the one or more of the locked features. The entity type may be associated with one or more privileges related to the processing of the encoded representation. The types of entities may include individual users, groups of users, customers, a class of customers, as well as other types of entities.

Processing the encoded representation according to the one or more unlocked features may involve storing the encoded representation for a storage duration associated with the embedded barcode. Alternatively or additionally, processing the encoded representation according to the one or more unlocked features may involve offering, via a computer interface, discounted purchase of one or more biological assays related to the processed encoded representation.

In some embodiments, the encoded representation may be of a sequence of nucleotides. The embedded barcode may consist of one or more nucleotide patterns not appearing in the sequence of nucleotides. The nucleotide patterns of the embedded barcode may include (i) one or more information regions, wherein the information regions contain respective sets of contiguous nucleotides that encode information related to the processing of the encoded representation, and (ii) one or more additional regions, wherein the additional regions contain contiguous nucleotides that are randomly selected. Further, the nucleotide patterns of the embedded barcode may include two or more information regions. Processing the encoded representation in the selected data processing pipeline or processing the encoded representation according to the one or more unlocked features may be based on a nucleotide distance between two of the two or more information regions.

In some embodiments, the selected data processing pipeline may be a micro RNA pipeline, and the embedded barcode may represent 15-30 nucleotides. Alternatively, the selected data processing pipeline may be a long RNA pipeline or a DNA pipeline, and the embedded barcode may represent 175-275 nucleotides. Other lengths of nucleotides are possible.

The computing device may be configured to simultaneously process at least 30 encoded representations in respective selected data processing pipelines according to respective unlocked features. Each encoded representation may represent hundreds or thousands of nucleotides or more. However, more or fewer encoded representations may be processed simultaneously. For instance, this simultaneous processing may involve 10, 20, 50, 100, or 1000 encoded representations, or another extent of encoded representations.

Particularly, simultaneous processing of such a large number of encoded representations necessitates computer implementation. DNA and RNA testing results are expected to be provided as rapidly as possible. This is especially important when testing a biological sample from a patient suspected of having a serious disease. Failure to provide rapid results could deleteriously impact the health of the patient. Since manual processing of large number of encoded representations would not be possible within the time frame required, the features described herein would not exist but for computer implementation thereof.

Further, the embodiments herein specify how a barcode encoding of nucleotides can be used to unlock features of a computing system. Thus, these embodiments yield a new result that allows automatic processing of DNA or RNA samples without human intervention or guidance. Thus, the intersection of the new features of these embodiments and the computer implementation thereof go beyond conventional and routine operations.

In some embodiments, a composition of matter may be formed from a sequence of nucleotides in the form of a barcode. The nucleotide patterns of the barcode may include one or more information regions that contain respective sets of contiguous nucleotides that do not appear in a known genome and encode information related to the processing of the encoded representation, and one or more additional regions that contain contiguous nucleotides that are randomly selected. The barcode may identify a particular biological testing kit.

Further, the barcode may be associated with an encoded representation of a biological sample. The barcode may refer to a data processing pipeline, of a computing system, for processing the encoded representation. The nucleotide patterns of the barcode may include two or more information regions, and processing the encoded representation in the data processing pipeline may be based on a nucleotide distance between two of the two or more information regions.

Additionally or alternatively, the barcode may encode information that unlocks one or more locked features of a computing system. Unlocking the one or more locked features of the computing system may involve determining an entity type associated with the barcode (e.g., an individual, group, or business), and based on the entity type, determining to unlock the one or more of the locked features.

### 5. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrent or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method comprising:
receiving, by a computing system, an encoded representation of a biological sample, wherein the encoded representation contains an embedded barcode, and wherein the computing system includes locked features;
based on the embedded barcode, (i) automatically selecting, by the computing system, a data processing pipeline for the encoded representation, and (ii) unlocking, by the computing system, one or more of the locked features; and
processing, by the computing system, the encoded representation in the selected data processing pipeline and according to the one or more unlocked features.

2. The method of claim 1, wherein the embedded barcode identifies a particular biological testing kit.

3. The method of claim 1, wherein the data processing pipeline is selected from the group consisting of a micro ribonucleic acid (RNA) pipeline, a long RNA pipeline, and a deoxyribonucleic acid (DNA) pipeline.

4. The method of claim 1, wherein unlocking the one or more of the locked features comprises:
determining an entity type associated with the embedded barcode; and
based on the entity type, determining to unlock the one or more of the locked features.

5. The method of claim 4, wherein the entity type is associated with one or more privileges related to the processing of the encoded representation.

6. The method of claim 4, wherein processing the encoded representation according to the one or more unlocked features comprises storing the encoded representation for a storage duration associated with the embedded barcode.

7. The method of claim 4, wherein processing the encoded representation according to the one or more unlocked features comprises offering, via a computer interface, discounted purchase of one or more biological assays related to the processed encoded representation.

8. The method of claim 1, wherein the encoded representation is of a sequence of nucleotides, and wherein the embedded barcode consists of one or more nucleotide patterns not appearing in the sequence of nucleotides.

9. The method of claim 8, wherein the nucleotide patterns of the embedded barcode include (i) one or more information regions, wherein the information regions contain respective sets of contiguous nucleotides that encode information related to the processing of the encoded representation, and (ii) one or more additional regions, wherein the additional regions contain contiguous nucleotides that are randomly selected.

10. The method of claim 9, wherein the nucleotide patterns of the embedded barcode include two or more information regions, and wherein processing the encoded representation in the selected data processing pipeline or processing the encoded representation according to the one or more unlocked features is based on a nucleotide distance between two of the two or more information regions.

11. The method of claim 8, wherein the embedded barcode is spiked-in to the sequence of nucleotides.

12. The method of claim 8, wherein the embedded barcode is covalently bounded to the sequence of nucleotides.

13. The method of claim 1, wherein the selected data processing pipeline is a micro ribonucleic acid (RNA) pipeline, and wherein the embedded barcode represents 15-30 nucleotides.

14. The method of claim 1, wherein the selected data processing pipeline is a long RNA pipeline or a deoxyribonucleic acid (DNA) pipeline, and wherein the embedded barcode represents 175-275 nucleotides.

15. The method of claim 1, wherein the computing device simultaneously processes at least 30 encoded representations in respective selected data processing pipelines according to respective unlocked features.

16. An article of manufacture including a non-transitory computer-readable medium, having stored thereon program instructions that, upon execution by a computing system, cause the computing system to perform operations comprising:
receiving an encoded representation of a biological sample, wherein the encoded representation contains an embedded barcode, and wherein the computing system includes locked features;
based on the embedded barcode, (i) automatically selecting a data processing pipeline for the encoded representation, and (ii) unlocking one or more of the locked features; and
processing the encoded representation in the selected data processing pipeline and according to the one or more unlocked features.

17. The article of manufacture of claim 16, wherein the data processing pipeline is selected from the group consisting of a micro ribonucleic acid (RNA) pipeline, a long RNA pipeline, and a deoxyribonucleic acid (DNA) pipeline.

18. The article of manufacture of claim 16, wherein unlocking the one or more of the locked features comprises:
determining an entity type associated with the embedded barcode; and
based on the entity type, determining to unlock the one or more of the locked features.

19. The article of manufacture of claim 16, wherein the selected data processing pipeline is a long RNA pipeline or a deoxyribonucleic acid (DNA) pipeline, and wherein the embedded barcode represents 175-275 nucleotides.

20. A computing system comprising:
at least one processor;
memory; and
program instructions, stored in the memory, that upon execution by the at least one processor cause the computing system to perform operations comprising:
receiving an encoded representation of a biological sample, wherein the encoded representation contains an embedded barcode, and wherein the computing system includes locked features;
based on the embedded barcode, (i) automatically selecting a data processing pipeline for the encoded representation, and (ii) unlocking one or more of the locked features; and
processing the encoded representation in the selected data processing pipeline and according to the one or more unlocked features.

21. A composition of matter comprising:
a sequence of nucleotides in the form of a barcode, wherein the nucleotide patterns of the barcode include:
one or more information regions, wherein the information regions contain respective sets of contiguous nucleotides that do not appear in a known genome and encode information related to the processing of the encoded representation, and
one or more additional regions, wherein the additional regions contain contiguous nucleotides that are randomly selected.

22. The composition of matter of claim 21, wherein the barcode identifies a particular biological testing kit.

23. The composition of matter of claim 21, wherein the barcode is associated with an encoded representation of a biological sample, and wherein the barcode refers to a data processing pipeline, of a computing system, for processing the encoded representation.

24. The composition of matter of claim 23, wherein the nucleotide patterns of the barcode include two or more information regions, and wherein processing the encoded representation in the data processing pipeline is based on a nucleotide distance between two of the two or more information regions.

25. The composition of matter of claim 21, wherein the barcode encodes information that unlocks one or more locked features of a computing system.

26. The composition of matter of claim 25, wherein unlocking the one or more locked features of the computing system comprises:
determining an entity type associated with the barcode; and
based on the entity type, determining to unlock the one or more of the locked features.
